(19) United States
(12) Patent Application Publication
(10) Pub. No.: US 2002/0048304 A1
(43) Pub. Date: Apr. 25, 2002

(54) Radiation emitting devices

(76) Inventors: William Leslie Barnes, Topsham (GB); Stephen Chistopher Kitson, Bristol (GB); John Roy Sambles, Crediton (GB)

Correspondence Address: NIXON & VANDERHYE P.C., 8TH Floor, 1100 North Glebe Road, Arlington, VA, 22201-4714, US

(21) Appl. No.: 09/983,713

(22) Filed: Oct. 25, 2001

Related U.S. Application Data
(63) Continuation of application No. 09/325,351, filed on Jun. 4, 1999, now abandoned.
Application No. 09/325,351 is a 371 of international application No. PCT/GB97/03356, filed on Dec. 4, 1997.

(30) Foreign Application Priority Data
Dec. 5, 1996 (GB) 9625332.3

(51) Int. Cl. H01S 3/08

(52) U.S. Cl. 372/99

(57) ABSTRACT

A radiation emitting device includes an optical micro-cavity bounded by first and second reflective boundaries (33,39), at least one of said reflective boundaries (39) has associated therewith inhibiting means, such as an array of hillocks or dimples, to inhibit the coupling of radiation from within the micro-cavity (31) to predetermined propagation modes, such as surface plasmon polaritons, associated with at least one of the reflective boundaries.

This invention relates to radiation emitting devices and, in particular, to an improved manner of construction for light emitting diodes. More particularly, but not exclusively, the invention relates to a micro-cavity for use in light emitting diodes.

Light emitting diodes (LEDs) comprise a light (radiation) emitting substance usually in the form of a thin film. This light emitting substance is usually positioned inside a mirrored cavity, sometimes called a micro-cavity. Two mirrors are used to form the micro-cavity and one of the mirrors is more reflective than the other. The less reflective of the two mirrors permits radiation to pass through it and escape from the micro-cavity, thus providing useful output light from the device.

Generally, the efficiency of an LED is increased by improving coupling between radiation modes of the micro-cavity and the light emitting substance. One way of achieving this is to ensure that the separation between the mirrors is of the order of the wavelength of the desired output radiation.

There are two types of mirror which have been used in LEDs. These are the distributed Bragg reflector (DBR)—usually made from alternating layers of different refractive index materials—and metallic mirrors. DBRs may be highly reflective, but only over a relatively narrow range of incident angles. Light incident at other angles leaks from the micro-cavity in the form of wasted output. Metallic mirrors however are reflective over a wider range of incident angles, but have losses associated with the absorption of the metal. Because metallic mirrors are generally thinner than the wavelength of light they allow the fabrication of very compact devices.

When light emitters, envisaged as point sources (and assumed to be oscillating electric dipoles), are near the surface of a metallic mirror they may couple to the so-called surface plasmon polariton (SPP) mode of that surface. This coupling is strongest when the separation between the emitter and mirror is approximately 1/60 of the order of the wavelength of the desired output radiation. However, coupling is still significant at approximately ½ of the wavelength of the desired output radiation. The coupling arises despite the surface plasmon polaritons (SPPs) being non-radiative, due to the non-planar nature of the dipole field of the emitter in the near field regime.

High momentum components of the near field part of the dipole field can couple to the SPP mode without the need for further momentum matching. These near field components in the dipole field are sometimes known as evanescent waves. The result is that for a typical micro-cavity operating in the visible region of the electromagnetic radiation (EMR) spectrum close to the lowest order mode cut-off of the micro-cavity, approximately 50% of the energy is wasted in generating SPPs rather than in producing useful, emitted radiation.

Loss of energy to SPP coupling and losses in metal layers represent wasted output. This problem has been discussed in publications in Physical Review A. 51, pp 4116-4122, 1995 by Abram and Oudar, and in Optics Communications. 100, pp 259-267, 1993 by Tomas and Lenac. These authors discuss the use of metallic mirrors in micro-cavities, the problems associated with loss due to the metals and the implications of this loss for light emitting diodes (LEDs).

The inventors have realised that in order to improve the quantum efficiency of an LED it is desirable to remove the unwanted coupling between the emitters and the SPP modes. This applies particularly to micro-cavities formed from two metallic mirrors and those formed from one metallic mirror and one DBR mirror. Since the primary reason for the wasted energy is the generation of surface plasmon polaritons, removing this mode from the micro-cavity is required in order that the efficiency can be improved.

It is therefore an aim of the present invention to provide an improved micro-cavity suitable for use in a more efficient light emitting device (for example light emitting diode (LED)), the device having a higher quantum efficiency of conversion of internal energy to useful radiated energy.

According to the present invention there is provided a radiation emitting device including an optical micro-cavity bounded by first and second reflective boundaries wherein at least one of said reflective boundaries has associated therewith inhibiting means to inhibit the coupling of radiation from within the micro-cavity to predetermined propagation modes associated with at least one of said first and second reflective boundaries.

There is also provided a radiation emitting device including an optical micro-cavity comprising first and second mirrors in which at least one of said mirrors has a substantially non-planar surface.

According to a further aspect of the present invention there is provided a light emitting device (e.g. LED) comprising first and second mirrors, one or both of which are metallic, defining a micro-cavity and a light emitting substance disposed in the micro-cavity, wherein at least one of the mirrors has a substantially non-planar surface.

According to another aspect of the present invention there is provided a light emitting device comprising a light emitting substance interposed between a first and a second mirror, each mirror having a surface, the mirrors defining a micro-cavity, wherein means is provided for establishing a photonic band gap substantially to reduce the coupling of energy from within the micro-cavity, to modes associated with at least one mirror surface.

According to a further aspect of the present invention there is provided a method of fabricating a radiation emitting device including a substrate with a repeating pattern comprising the steps of causing a master pattern to induce a first repeating pattern to be formed on the substrate, rotating the master pattern with respect to the substrate and inducing a second repeating pattern to be formed on the substrate, the two repeating patterns sharing a common region.

The non-planar mirror(s) or reflector(s) may be fabricated according to the method hereinafter described and is/are preferably in the form of an array of “hillocks” or “dimples”, having a repeating pattern The pattern may be generally rectangular, but is preferably, generally hexagonal.

Portions of substrate may be selectively removed by etching techniques such as ion beam lithography, photo-lithography or chemical etching.

According to yet a further aspect of the present invention there is provided a method of manufacturing a radiation emitting device incorporating a sub-micron, repeating pattern in or on a dielectric substrate comprising the steps of placing a pattern bearing mask between the surface of the substrate and an energy source, exposing the substrate to the energy source and forming a pattern rotating the mask with respect to the substrate, re-exposing the surface of the substrate to the energy source thereby forming another pattern and selectively removing portions of exposed or non-exposed substrate, so as to reveal a repeating pattern on or in the substrate.

Preferably the pattern is in the form of a plurality of regularly spaced, undulating regions. Advantageously these regions are in the form of raised circularly symmetric “hillocks” or “dimples” and the overall effect of such a surface approximates closely to a circular Brillouin zone.

Preferably the substrate is fabricated by using a system of multiple exposures in a standard two beam interferometer. Preferably three exposures, with the substrate rotated by 60° between each exposure is required in to obtain an hexagonal structure. However, this requires a high degree of precision by ensuring all three exposures are exactly in register. In practice this is difficult. Most preferably two exposures may be made, followed by selective partial etching in order to achieve a desirable intensity profile of pattern across the substrate.

The invention will now be particularly described by way of example with reference to the accompanying drawings, in which:

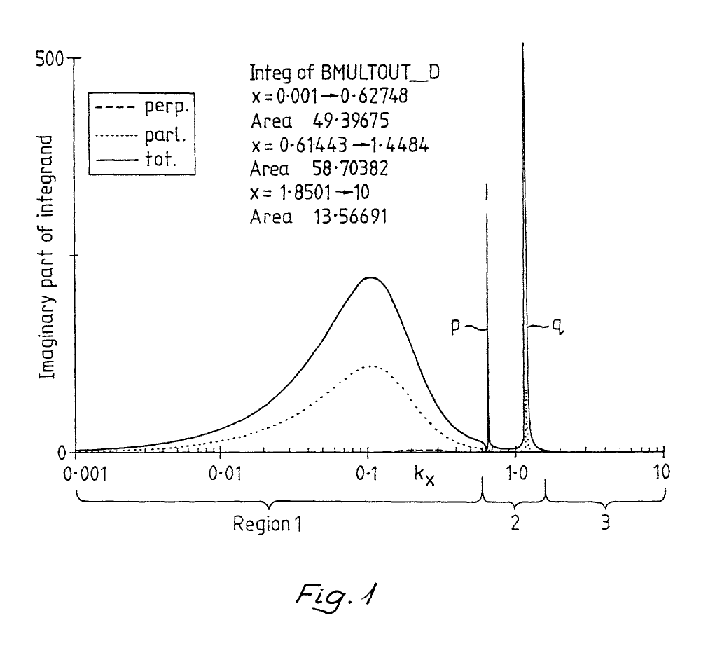

FIG. 1 shows a theoretical prediction in the form of a logarithmic scaled graph of the energy dissipated due to different causes, as a fraction of the total energy available for the production of radiation from an LED with metallic mirrors.

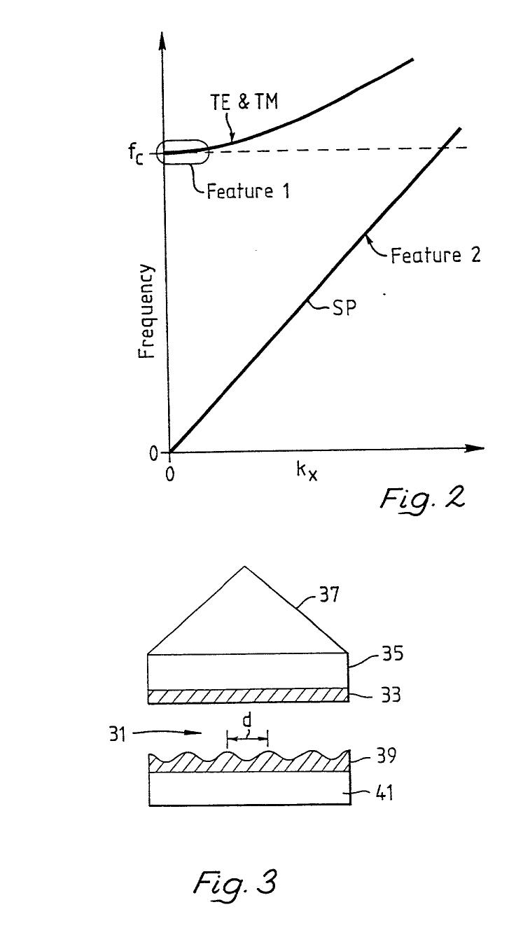

FIG. 2 shows a dispersion curve for a micro-cavity with metallic mirrors.

FIG. 3 is a schematic view of a micro-cavity used to demonstrate the prohibition of the SPP decay channel;

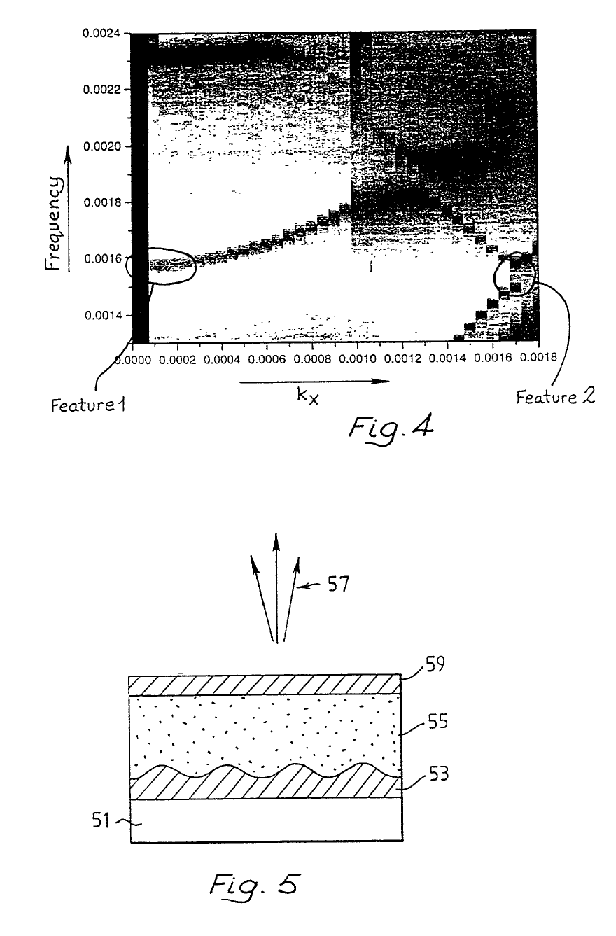

FIG. 4 is a graph of the measured dispersion curve for the micro-cavity depicted in FIG. 3.

FIG. 5 is a schematic diagram of one possible LED structure that exhibits improved efficiency by incorporating a non-planar mirror for one of the mirrors that forms the micro-cavity;

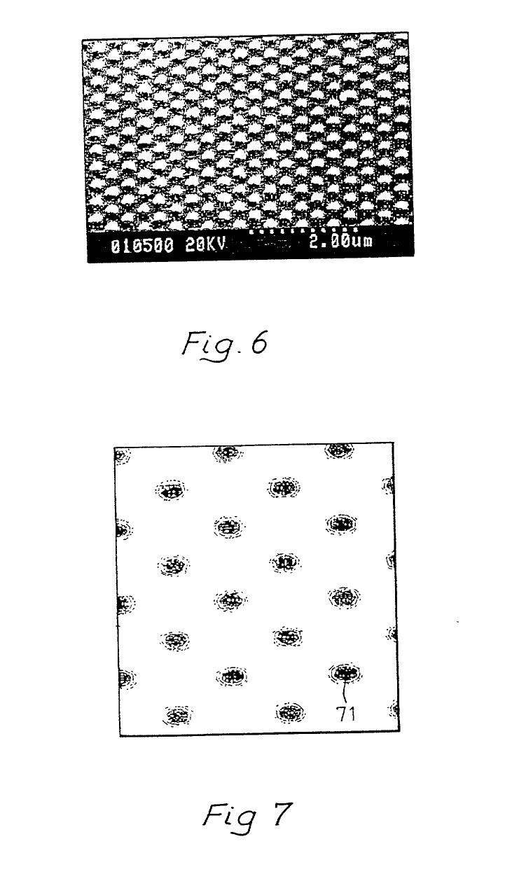

FIG. 6 is a scanning electron micrograph (SEM) image of a non-planar metallic surface that exhibits photonic band gap for surface plasmon polariton modes in the red part of the visible spectrum.

FIG. 7 is a theoretically produced intensity distribution for the exposure of photoresist to two grating patterns, oriented at 60 degrees with respect to each other;

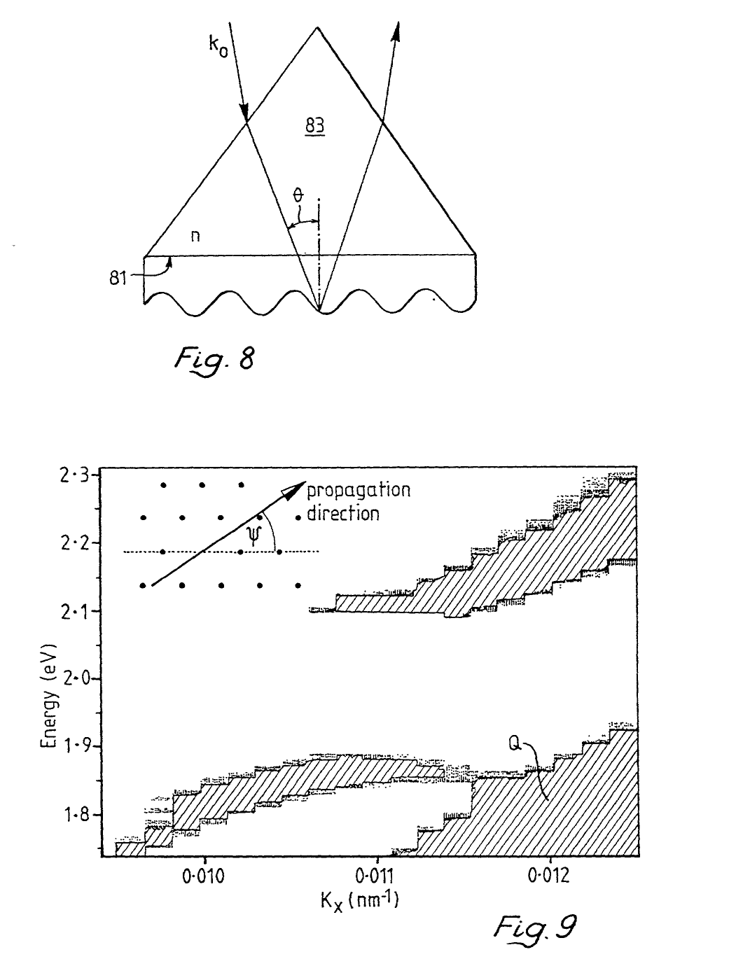

FIG. 8 is a schematic of the prism coupling technique used to measure the SPP band gap (i.e. band structure) of a textured surface similar to that shown in FIG. 5;

FIG. 9 is the measured dispersion curve for surface plasmon polarity modes propagating on a surface similar to the one shown in FIG. 6.

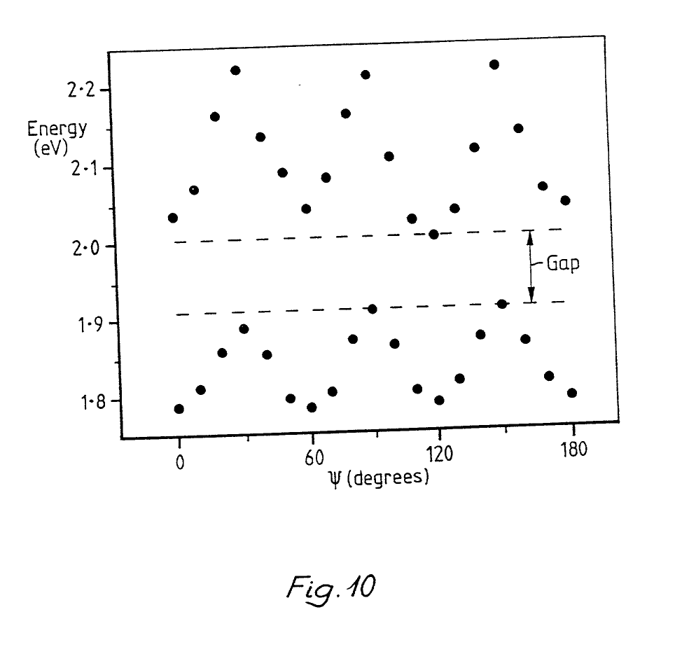

FIG. 10 shows how the energy of the band gap edges. FIG. 9, vary with propagation angle.

Referring to the drawings, a graphical illustration of the relative importance of different decay channels is shown below in FIG. 1, which depicts (on a logarithmic scale) relative amounts of energy, generated in a micro-cavity. The integrals under the different regions of the curve indicate the relative values of energy dissipated. Region 1 represents energy dissipated as potentially useful radiation. Region 2 represents energy dissipated coupling to SPP modes on all metal surfaces of mirrors. Region 3 represents energy losses due to the metal and are important only for emitters very close (i.e. less than approximately 1/60 the wavelength of the radiation) to the metal. It is apparent that the area in region 1, which is potentially useful radiation, represents approximately 50% of the total theoretical energy available.

For small values of micro-cavity (d) (where d is the inter-mirror spacing and is less than approximately 20 nm), the lifetime of a light emitting device rapidly drops as fluorescence is quenched.

Blocking the propagation of modes in all directions requires a repeating pattern with a Brillouin zone that is as close to circular as possible. A surface with hexagonal symmetry is a reasonable approximation to this pattern.

The desired effect of a non-planar mirror on the surface plasmon polariton modes, i.e. prohibiting their propagation, is demonstrated with a simple micro-cavity structure as described below with reference to FIG. 3. The allowed modes of the metallic mirrored micro-cavity are represented on a dispersion curve, in FIG. 2. The frequency of allowed modes, as a function of in-plane wave vector, kₓ is shown. The dipole emitters have a fixed frequency, but may couple to modes with any value of kₓ at that frequency. The desired radiation mode of the micro-cavity is also indicated on FIG. 2 as feature 1. It is seen from FIG. 2 that another mode, indicated as feature 2 in FIG. 2, is also present at the same frequency as feature 1. Feature 2 is a surface plasmon polariton (SPP) mode of the metallic micro-cavity. By corrugating one of the metallic surfaces this unwanted mode can be eliminated. FIG. 3 shows a cavity 31 between a planar silver layer 33 on a glass plate 35 provided with a glass prism 37 and a corrugated optically-thick silver layer 39 on a glass substrate 41. This is a schematic view of a micro-cavity used to demonstrate the prohibition of the SPP decay channel.

Corrugation is preferably in the form of a repeating (‘periodic’) pattern. Preferably the pattern required is in the form of a non-planar surface and comprises an array of “hillocks” or “dimples” arranged so that the distance between “hillocks” or “dimples”, d, is given approximately by,

2kₛₚₚ=2π/d

(where kₛₚₚ is the wave vector of a surface plasmon polariton).

The non-planar surface of one of the mirrors (or reflectors) effectively Generates a broad photonic band gap for surface plasmon polaritons (SPPs) and thereby reduces the overall loss of energy from the light emitting device which has hitherto occurred due to coupling between the light emitters and the SPP modes of the metallic mirrors. The radiation efficiency of the device is thus greatly improved.

An optical or electrical pump source may be fabricated integrally with the light emitting device or it may added as a part finished device for subsequent use.

Surface plasmon polaritons are non-radiative TM polarised modes that propagate at the interface between a metal and a dielectric. The inventors have realised that in order to generate a photonic band gap, a wavelength scale periodicity has to be introduced. For a surface plasmon polariton this may be readily achieved by corrugating the metal/dielectric surface of a mirror defining the micro-cavity. However, it will be appreciated that other ways of achieving this objective may be possible, including for example and without limitation, modulating the or each refractive index of the material(s) within the micro-cavity.

A corrugated surface however, only blocks the propagation of surface plasmon polaritons over a narrow range of directions. In order to generate a full band gap, (that is one that will block the propagation of surface plasmon polaritons in all directions on the surface), a more complex periodic structure is required. This is necessary if blocking the propagation of surface plasmon polaritons is to have a significant effect on the properties of metallic micro-cavities.

A theoretical prediction in the form of a logarithmic scaled graph of the energy dissipated due to different causes, as a fraction of the total energy available for the production of radiation from an LED with metallic mirrors is shown in FIG. 1. The dipole moments that make up the emitters are assumed to be randomly oriented and dispersed throughout the region between the mirrors;

FIG. 2 shows the dispersion curve for a micro-cavity with metallic mirrors. TE is the lowest order transverse electric mode of the micro-cavity, TM is normally the lowest order transverse magnetic mode of a micro-cavity, but, because the mirrors of the micro-cavity depicted are metallic, another mode exists, namely the surface plasmon polariton mode, (SPP). A light emitting diode based on a micro-cavity may be operated on or around cut-off, i.e. at a frequency marked as f_{c}. The presence of the SPP mode at this frequency provides an unwanted loss mechanism for the dipole emitters located within the micro-cavity.

FIG. 4 is a Graph of the measured dispersion curve for the micro-cavity depicted in FIG. 3. Feature 1 is the lowest order radiative mode, namely the one into which it is desired the emitters couple to produce a useful output from the device. The unwanted surface plasmon polariton mode is depicted as being blocked by a band gap. (feature 2); contrast this with the dispersion curve of the planar cavity, FIG. 3. By adjusting the pitch of the corrugation this gap can be made to coincide with the frequency of the lowest order radiative mode, feature 1 of FIG. 4, thus preventing or eliminating loss due to coupling between emitters and surface plasmon polariton modes. This prevents or eliminates loss due to coupling between emitters and surface plasmon polariton modes. This band gap pertains to only one direction of SPP mode propagation. An array of “hillocks” or “dimples” produces a band gap in all propagation directions (as described below) and thus eliminates or prevents the wasteful SPP coupling in light emitting devices in all directions.

FIG. 5 is a schematic diagram of one possible light emitting diode structure that exhibits improved efficiency by incorporating a non-planar mirror for one of the mirrors that forms the micro-cavity. It has a substrate 51 which carries a textured lower metal mirror 53. An optical cavity 55 includes a light emitting substance. Useful optical radiation is emitted through a thin top mirror 59.

FIG. 6 is a scanning electron micrograph of such a surface with a periodicity suitable for work at optical frequencies. The “hillocks” or “dimples” are formed from a photoresist deposited onto a fused silica substrate. The whole surface is subsequently coated with a relatively thick silver film which is preferably in the region of 20-60 nm and most preferably substantially more than 40 nm thick. The silver film supports the propagation of surface plasmon polaritons. The fabrication and operation of this structure is described in greater detail below.

FIG. 7 shows an intensity map which does not have full hexagonal symmetry. This pattern is achieved by exposing the substrate only twice. There is, however, an hexagonal array of dark regions 71 that have received relatively low amounts of exposure. By making use of the fact that there is a threshold value of exposure needed to affect photoresist, it is possible to remove all the exposed parts of the substrate, leaving just the aforementioned unexposed regions. This technique subtly achieves the same effect as three exposures and only requires two exposures, whilst still revealing an hexagonal array of “hillocks” or “dimples”. The advantage is that only two exposures are required and these are achieved with relative rotation of mask and substrate. The resultant effect is easier to attain because it is easier to expose a repeating linear pattern, rotate the pattern (with respect to the substrate) and re-expose the same pattern: than to try and ensure co-registration of three repeating linear patterns on a sub-microscopic scale.

In order to measure optically the band structure of surface plasmon polaritons (SPPs) a method is needed to couple the SPPs to photons. The surface modes are non-radiative, so that at a given energy SPPs have a larger wave vector than a photon of the same frequency. In order to provide coupling . the wave vector of the photon has to be enhanced. This can be done using a standard prism coupling technique as shown for example in FIG. 8. The uncoated face 81 of a fused silica substrate is brought into contact with a silica prism 83, by means of a matching fluid (not shown). Monochromatic radiation k₀, incident through the prism, may then excite surface plasmon polaritons which propagate on the air/silver interface. Energy is absorbed from the beam, reducing the reflectivity. For a given photon energy, resonant coupling occurs when the in-plane component of the photon wave vector (kₓ) matches the surface plasmon wave vector (kₛₚₚ). That is when θ satisfies the relation

nk₀ sinθ=kₛₚₚ

where n is the refractive index of the prism and k₀ is the vacuum wave vector of the incident photon.

The band structure was measured by recording reflected intensity as a function of the photon energy and kₓ. A white light source and a computer controlled spectrometer were used to produce a collimated TM polarised monochromatic beam in the wavelength range 400 nm to 800 nm. The angle of incidence was controlled by placing the sample on a computer controlled rotation stage capable of 0.01° resolution.

FIG. 9 shows a typical set of reflectively data recorded in this way. The regions of low reflectivity (dark) are a result of photons that have been absorbed through the resonant excitation of surface plasmons. Since these photons match both the energy and the wave vector of the surface plasmon polaritons, the dark bands in FIG. 9, directly map out the dispersion curve of the surface mode. There is a clear gap in the dispersion curve centred around 1.98 eV. The reflectivity data is expressed as photon energy (eV) as a function of kᵣ. Lighter regions represent high reflectivity and darker regions correspond to low reflectivity. The dark triangle (Q) in the tower right corner is an artefact of the measurement technique. The propagation direction ψ is defined with respect to one of the principal Bragg vectors. Experimentally this may be determined by diffracting a 457.9 nm wavelength beam from an argon ion laser.

In order to map out the entire band structure of the surface plasmon, dispersion curves were recorded for the full range of propagation directions. Surface plasmons excited via the aforementioned prism coupling propagate in the direction defined by the plane of incidence of the photons. The propagation direction is determined therefore by the angle between the plane of incidence and a particular Bragg vector in the textured surface as seen in FIG. 10.

The dispersion curve for each direction exhibits a clear gap, the energies of the upper and lower branches depending on ψ is shown in, FIG. 10. It is clear that there is a full gap between 1.91 eV and 2.00 eV. That is there are no propagating modes in this energy range in any direction on the silver/air interface.

An example of one method of fabricating a substrate having a repeating sub-micron hexagonal array is described in detail in IEEE Photonics Technology Letters 8 No. 11.

An hexagonal array is made by first exposing the substrate twice to the same interference pattern, with the substrate rotated by 60° about its surface normal between exposures. For each exposure, the intensity profile in the interference pattern is sinusoidal. FIG. 7 shows the sum of two such interference patterns and represents the total exposure at each point across the photoresist film. This pattern does not have hexagonal symmetry. In principle, hexagonal symmetry could be achieved by making a third exposure with the substrate rotated by a further 60°, but this would require setting the interference pattern exactly in register with the previous two. As this would mean aligning the sample accurately on a sub-micron scale, this is not generally practicable.

An alternative approach is to make use of nonlinearities in the fabrication process to generate additional Fourier components in the surface topography of the substrate. In particular, the aim is to produce a strong component that is the sum of the two components present in the double exposure. True hexagonal symmetry requires that these three components have the same magnitude. The nonlinearities arise from the solubility response of the photoresist to exposure and the finite thickness of the film.

The solubility response of photoresist as a function of exposure exhibits a threshold value below which the solubility is relatively unaffected, and a saturation level at very high exposures. A positive photoresist was used so that the regions exposed to less than the threshold value remain insoluble in the developer. In FIG. 7 there is an hexagonal array of points (dark) which receive a very low exposure. It is these points that form the “hillocks” or “dimples” in the final structure. By controlling the exposure level, it is possible to ensure that all other re-ions of the film receive an above-threshold exposure and so will be soluble to some extent. Upon development, these regions begin to dissolve and become thinner, producing a surface texture that reflects the exposure pattern (FIG. 7). However, because the film is thin (typically 0.5 μm), the exposed regions will eventually completely dissolve to leave an hexagonal array of photoresist “hillocks” or “dimples” 71 on the substrate surface (FIG. 7). This model predicts that the surface cannot have true hexagonal symmetry: the “hillocks” or “dimples” in FIG. 6 are not circular in cross section but are elongated in one direction. This feature however was not observed experimentally (FIG. 6). It may be that the development process acts to round off the “hillocks” or “dimples”.

FIG. 6 is an SEM of a structure fabricated with a positive resist. Shipley S1805 photoresist was used, mixed 1:1 with Hoechst AZ thinners. The photoresist was spin-coated at 4000 rpm onto an optically flat glass substrate and baked at 95° C. for 30 min to remove residual solvent. The film was exposed twice in the interferometer, the substrate being rotated by 60° between exposures. In each case, the film was exposed to around 3 Jcm⁻² of 457.9 nm wavelength radiation from an argon ion laser. The photoresist was subsequently developed for 4.5 min in a solution of Microposit™ developer diluted 1:1 with deionised water. It was found that control of the developer concentration was critical. If the developer was too concentrated then it removed all the photoresist. If it was too dilute then it failed to dissolve the film fully even in the most exposed regions.

The structure in FIG. 6 is not truly hexagonal because of inaccuracies in setting the rotation angle of 60°. FIG. 6 includes a schematic diagram showing the dimensions of the array, determined by measuring the diffraction of 457.9 nm light. The uniformity of the array is very good with few defects and with “hillocks” or “dimples” of very similar sizes, around 100 nm radius.

The periodicity of the array is readily controlled by the angle of incidence θ of the two beams in the interferometer. The radius of the “hillocks” or “dimples” depend on the periodicity of the interference pattern the value of the threshold exposure, and on the total exposure used. For such small features, however, there are a number of other factors which may limit the size. These include the effect of surface tension, the dependence of the development rate on surface curvature, and on the size of the smallest particle that can be removed by the developer. With a pitch of 300 nm, the smallest “hillocks” or “dimples” that have been fabricated have a radius of 50 nm.

Reproducibility may be improved by using a larger pitch which in turn would result in larger “hillocks” or “dimples” which may be less prone to attack by the developer.

A technique of using a double exposure in a two-bean interferometer, has been shown to be able to fabricate an hexagonal array of 50-nm-radius “hillocks” or “dimples”. This is made possible through the use of nonlinearities in the exposure and development processes. By using a positive resist to produce an array of “hillocks” or “dimples”, the same approach may be used with a negative resist to make an array of holes. Although it is possible to fabricate such structures using electron beam lithography and laser-focused atom deposition, the technique that we have used has the potential of being a cheap and versatile alternative that avoids the need for a mask.

An embodiment of the invention has been described by way of example only, and it will be appreciated that variation may be made to the embodiment without departing from the scope of the invention. For example, the micro-cavity may be incorporated into other optical or opto-electronic devices such as an interferometer.

1. A radiation emitting device including an optical micro-cavity bounded by first and second reflective boundaries (33,39) characterised in that at least one of said reflective boundaries (39) has associated therewith inhibiting means to inhibit the coupling of radiation from within the micro-cavity (31) to predetermined propagation modes associated with at least one of said first and second reflective boundaries.

2. A radiation emitting device according to claim 1 characterised in that said inhibiting means comprises a variation in the or each refractive index of material within the microcavity.

3. A radiation emitting device according to claim 1 characterised in that means are provided for establishing a photonic band gap to inhibit the coupling of energy from within the micro-cavity, to modes associated with at least one reflective boundary.

4. A radiation emitting device according to claim 1 characterised in that the optical micro-cavity comprises first and second minors in which at least one of said mirrors has a substantially non-planar surface.

5. A radiation emitting, device according to claim 4 characterised in that said nonplanar surface is in the form of a plurality of regularly spaced, undulating regions having a repeating pattern.

6. A radiation emitting device according to claim 5 characterised in that said nonplanar surface is arranged so that the distance, d, between said undulating regions is substantially given by.
2kₛₚₚ=2π/d
where kₛₚₚ is the wave vector of a surface plasmon polariton which it is desired to inhibit.

7. A radiation emitting device according to claim 5 or claim 6 characterised in that said nonplanar surface is in the form of a plurality of regularly spaced, undulating regions having, a repeating pattern which is generally polygonal.

8. A radiation emitting device according to claim 7 characterised in that said nonplanar surface is in the form of a plurality of regularly spaced, undulating regions having a repeating pattern which is generally rectangular.

9. A radiation emitting device according to claim 7 characterised in that said nonplanar surface is in the form of a plurality of regularly spaced, undulating regions having a repeating pattern which is generally hexagonal.

10. A method of manufacturing a radiation emitting device incorporating a sub-micron, repeating pattern in or on a dielectric substrate comprising the steps of placing a pattern bearing mask between the surface of the substrate and an energy source exposing the substrate to the energy source and forming a pattern rotating the mask with respect to the substrate, re-exposing the surface of the substrate to the energy source thereby forming another pattern and selectively removing portions of exposed or non-exposed substrate, so as to reveal a repeating pattern on or in the substrate.

11. A method of fabricating a radiation emitting device including a substrate with a repeating pattern comprising the steps of causing a master pattern to induce a first repeating pattern to be formed on the substrate, rotating the master pattern with respect to the substrate and inducing a second repeating pattern to be formed on the substrate, the two repeating patterns sharing a common region.

12. An optical pump source characterised in that it includes a radiation emitting device in accordance with any one of claims 1 to 9.

13. An interferometer characterised in that it includes a radiation emitting device in accordance with any one of claims 1 to 9.
